(19) United States
(12) Patent Application Publication
(10) Pub. No.: US 2022/0382908 A1
(43) Pub. Date: Dec. 1, 2022

(54) PRIVATE JOINING, ANALYSIS AND SHARING OF INFORMATION LOCATED ON A PLURALITY OF INFORMATION STORES

(71) Applicant: Meta Platforms, Inc., Menlo Park, CA (US)

(72) Inventors: Naga Venkata Siva Rama Prasad BUDDHAVARAPU, Sammamish, WA (US); Milan SHEN, San Francisco, CA (US); Xiaopeng WU, Kenmore, WA (US)

(73) Assignee: Meta Platforms, Inc., Menlo Park, CA (US)

(21) Appl. No.: 17/701,329

(22) Filed: Mar. 22, 2022

Related U.S. Application Data
(60) Provisional application No. 63/192,934, filed on May 25, 2021.

(51) Int. Cl. G06F 21/62; G06F 21/60; G06F 16/2455

(52) U.S. Cl. CPC G06F 21/6263; G06F 21/602; G06F 21/6254; G06F 16/2456; G06F 16/24556

(57) ABSTRACT

According to examples, a system for generating and delivering enhanced content utilizing remote rendering and data streaming is described. The system may include a processor and a memory storing instructions. The processor, when executing the instructions, may cause the system to access a first data store with first information and a second data store with second information and align the first information with the second information to generate an aligned set. The processor, when executing the instructions, may then perform a computation on one or more identifiers utilizing the generated aligned set and reveal a differentially private output to one or more receiving parties.

### TECHNICAL FIELD

This patent application relates generally to data security and protection, and more specifically, to systems and methods for privately joining, analyzing and sharing information utilizing data available on a plurality of information stores.

### BACKGROUND

The proliferation of electronic commerce has led to users transacting with multiple providers for goods and services that they seek. As a result, large amounts of user-related transaction information may be gathered across various providers. It may be appreciated that analysis of such information may provide greater insight in user behavior, and may be used to recommend goods and services.

For these reasons, it may be beneficial for a first entity (e.g., an e-commerce company) and a second entity (e.g., a social media application provider) to “match” transaction information in their possession. However, it should also be appreciated that contractual and/or legal protections may be in place to protect user rights and privacy, and sharing such information may lead to legal repercussions and reduced user trust.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIG. 1A illustrates a block diagram of a system environment, including a system, that may be implemented to privately join, analyze and share of information based on data available on a plurality of information stores, according to an example.

FIG. 1B illustrates a block diagram of the system that may be implemented to privately join, analyze and share of information based on data available on a plurality of information stores, according to an example.

FIG. 1C illustrates a flow diagram of private joining, analyzing and sharing of information, according to an example

FIG. 1D illustrates an example of first information and second information to be aligned, according to an example.

FIG. 1E illustrates a flow diagram implementation of a private matching method, according to an example.

FIG. 1F illustrates a column of aligned values with first information and second information, according to an example.

FIG. 1G illustrates a flow diagram of performing a computation on one or more identifiers, according to an example.

FIG. 1H illustrates a joint computation that may be implemented, according to an example.

FIG. 2 illustrates a block diagram of a computer system to that may be implemented to detect account compromise via use of dynamic elements in data identifiers, according to an example.

FIG. 3 illustrates a method for detecting account compromise via use of dynamic elements in data identifiers, according to an example.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on.

The proliferation of electronic commerce has led to users transacting with multiple providers to secure goods and services. Typically, to conduct a transaction electronically, a user may provide one or more pieces of personal information, such as a user's name, address and/or credit card information. Also, a provider may typically generate information associated with a transaction, such as a content item/advertisement viewed, a time of purchase and/or a manner of purchase.

In some instances, this may have led to large amounts of user-related transaction information being gathered across various providers. It may be appreciated that analysis of such information may provide greater insight into user behavior, and that in some examples, a plurality of entities may seek to “align” available information to determine related aspects and/or commonalities. As used herein, a “commonality” may include any aspect that may be associated with a first and a second data store. In one example, a first entity having time or purchase information for a product (e.g., an e-commerce company) and a second entity having viewing information for advertisements related to the product (e.g., a social media application provider) may wish to “match” records to gather insight into user behavior.

In some examples, aligning information between a plurality of entities may include joining data between two data stores (e.g., a first database and a second database). In other examples, this may include joining data between a first table in a first data store and a second table in a second data store. In still other examples, this may include joining data from a first data set stored in a file with data from a second data set stored in the file.

In some examples, a first entity and a second entity who may each have a list of contacts (e.g., email addresses) may store these contacts in a first data store and a second data store respectively. In these instances, the first entity and the second entity may wish to know a number of common contacts. One way may be to have both parties share their contacts with the other. Unfortunately, however, requires each entity availing all contacts regardless of whether it may constitute a match, and resulting in “over-sharing”.

In some instances, entities in possession may be reluctant to share this information. Users typically trust entities with their information based on an expectation of privacy and responsible usage. Moreover, in some instances, contractual and/or legal protections may be in place to protect user rights and privacy. Consequently, sharing of this information may entail infringing user privacy rights or violating legal rights.

“Privacy enhancing technologies” (PETs) may refer to a family of technologies that may enable information to be analyzed while still protecting privacy. So, in some examples, privacy enhancing technologies (PETs) may enable analysis of information of a first entity in a first data store and information of a second entity in a second data store without sharing of information to either party. Furthermore, in some examples, the privacy enhancing technologies (PETs) may also enable generation and private sharing of a desired output based on the analysis.

Privacy enhancing technologies (PETs) may be applicable in a number of use cases. One such example may be “record-level computing”, which may include analysis of data associated with an entity, such as an individual or an organization. Record-level computing may be useful in various contexts, including developing targeted advertising for goods and services and analyzing data associated with healthcare support systems.

One example of a privacy enhancing technology (PET) may include a private set intersection (PSI). Private set intersection (PSI) may enable an encrypted version of a first data set and an encrypted version of a second data set to compute an intersection. As used herein, an “intersection” may include one or more elements that a first data set and a second data set may have in common, or may provide a commonality between a first data set and a second data set. So, in one example, private set intersection (PSI) may be implemented where a first entity with a first set of contacts and a second entity with a second list of contacts may both generate a list of contacts (e.g., email addresses) for an event they may be jointly planning. In this example, the first entity and the second entity may wish to know how many people (total) may be attending (i.e., an intersection) without sharing their list of contacts with the other entity.

In some examples, private set interaction (PSI) may implement a form of double encryption. To implement double encryption, in one examples, a first entity with a first data set and a second entity with a second data set may encrypt their own data sets (e.g., a list of email addresses) and may exchange to the other party. Next, the first entity and the second entity may (re)encrypt the encrypted data sets, shuffle the encrypted data sets to ensure each email address may not be linked back to its originating row), and then may share it back to the other entity. Once shared back, both the first entity and the second entity may see how many elements may be common. As such, both parties may learn how many elements may be same, but may not be privy to what the (same) elements may be.

Other examples of privacy enhancing technologies (PETs) may enable more complex analysis and sharing of information associated with data store(s). So, in some examples, these privacy enhancing technologies (PETs) may provide varied downstream computations on larger data sets, while keeping any information other than a final outcome protected. A first example of such a privacy enhancing technology (PET) may be multi-party computation (MPC). Multi-party computation (MPC) or “secure” multi-party computation (MPC) may include one or more methods for parties to jointly compute a function over inputs while keeping the inputs private. A second example of such a privacy enhancing technology (PET) may include homomorphic encryption (HE). Homomorphic encryption (HE) may enable users to perform computations on encrypted data without first decrypting it. However, while these technologies may be configured to provide solutions to address privacy issues across disparate information stores, their implementation may be also be prohibitively expensive as well.

Systems and methods for privately joining, analyzing and sharing information associated with data available on a plurality of information stores are provided. In some examples, the systems and methods described may enable computations using data originating from disparate entities and/or disparate sources while verifiably protecting personal and/or proprietary data. Also, in some examples, the systems and methods may provide private aligning of data records, including implementation of one or more protocols that may establish private identifiers for private joining and aligning of data set(s) across parties, determine a union or intersection across the data set(s), utilize a pre-defined condition to determine an equivalency across the data set(s) and may implement a function to generate a computation result. In some examples, the systems and methods may implement the one or more protocols to privately determine whether a particular item, action or event may be used. Examples of settings where the systems and methods described may be implemented may include online applications, such as social media platforms, electronic commerce applications and financial service applications.

In some examples, the systems and methods may utilize one or more multi-party computation (MPC) techniques to maintain inter-party privacy, wherein private matching and private attribution may be implemented without leaking of personal and/or proprietary information. In some examples, private matching may include privately aligning a first entity's information with a second entity's information without explicitly revealing “links” in the process. As used herein, a “link” may indicate a relationship and correspondence between a first data item (e.g., a first data row) of data in a first data store (e.g., a first data set), and a second data in a second data store (e.g., a second data set). Moreover, in some examples, the systems and methods may provide alignment information as well. In some examples, the alignment information may indicate that a first row in a plurality of data sets may correspond to a same individual. However, it should be appreciated that in these instances, the alignment information may not indicate underlying information of an associated record or the associated individual.

In some examples, the systems and methods may perform a join function (e.g., an outer join function) between two data stores (e.g., databases). In these examples, any information about disparate sets of proprietary information (e.g., records) other than information associated with an intersection between the disparate sets may not be revealed. An example may include a size of items in the intersection between the disparate sets (e.g., how many records overlap). In some examples, the systems and methods may utilize cryptographic techniques (e.g., elliptical curve cryptography) to ensure privacy of proprietary information during an exchange of information.

In some examples, the systems and methods may perform a join function (e.g., an inner join) between data records from a first private data source and a second private data source, and may output encrypted values of matching records. Also, in some examples, the outputted matching records may be encrypted (i.e., as “additive secret shares”) with each entity receiving only partial data and requiring another entity's cooperation to reveal any underlying data.

Furthermore, in some examples, the systems and methods may implement private attribution. In some examples, private attribution may be implemented to generate a determination associated with a first data source and a second data source. As used herein, a “determination” may include a result of any computation performed. Also, in some examples, private attribution may be utilized to generate a characteristic associated with the first data source and the data source. As used herein, a “characteristic” may include any aspect associated with a computation performed. So, in some examples, the private attribution may be used to determine one or more common aspect(s) between data items in the first data source and the second data source. In other examples, private attribution may be utilized to determine a relationship between the first data store and the second data store. So, in some examples, the private attribution may be used to determine an interaction between a first data item in the first data store and a second data item in the second data store. As used herein, an “interaction” may include a relationship where a first aspect may exhibit a correspondence with a second aspect.

In particular, in some examples, private attribution may include utilization of an attribution logic. In these examples, the attribution logic may be used to analyze information of a first entity from a first data store and information of a second entity from a second data store relating to a same item (e.g., a user) without revealing the other data records to each entity. In particular, in one example, private attribution may be used to analyze an engagement event (e.g., the first data) and a purchase event (i.e., the second event) to assign a “conversion credit” to an associated content item.

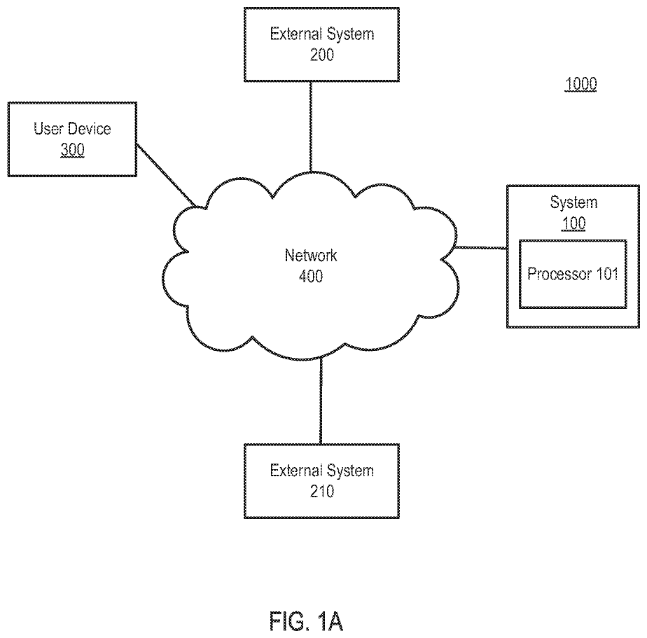

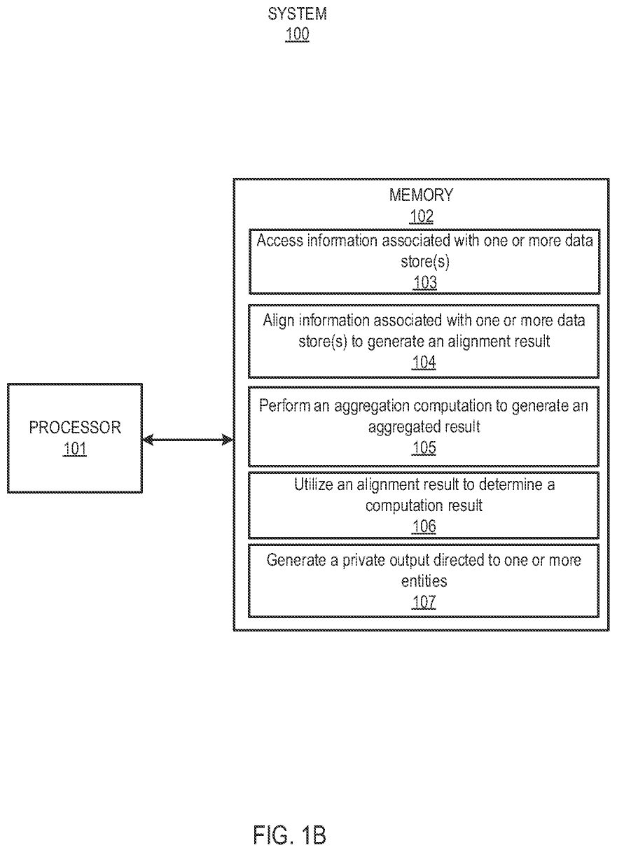

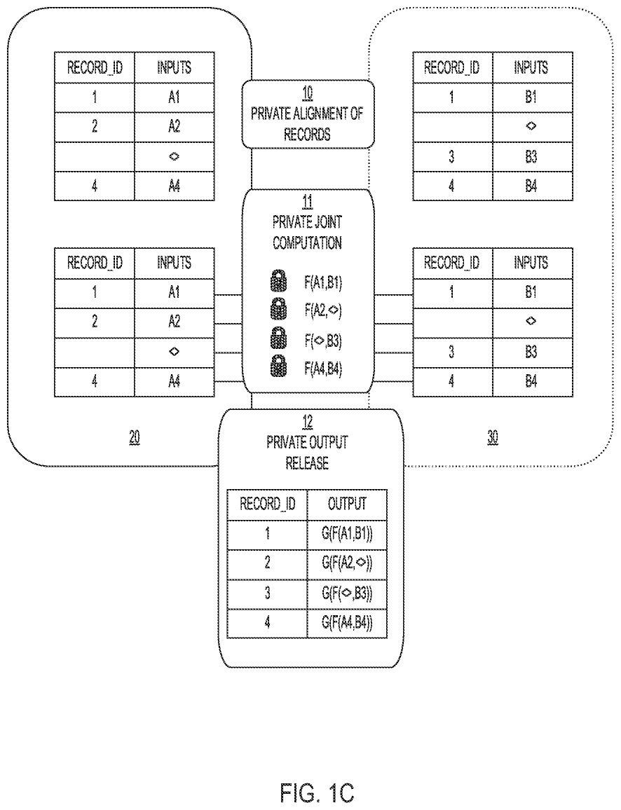

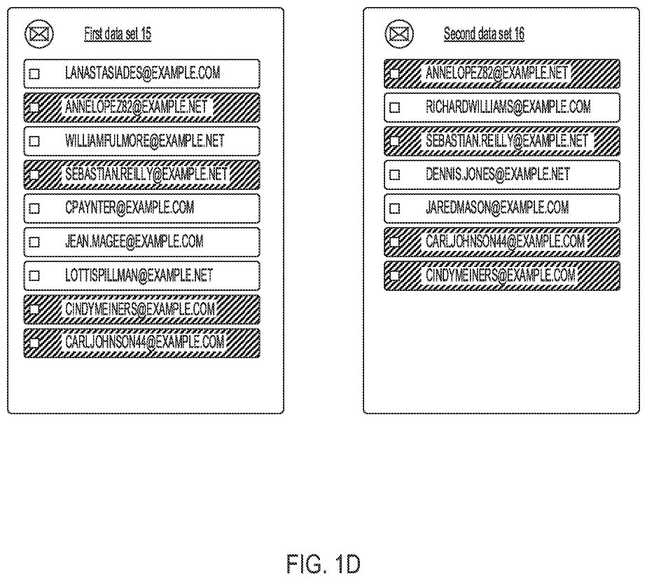

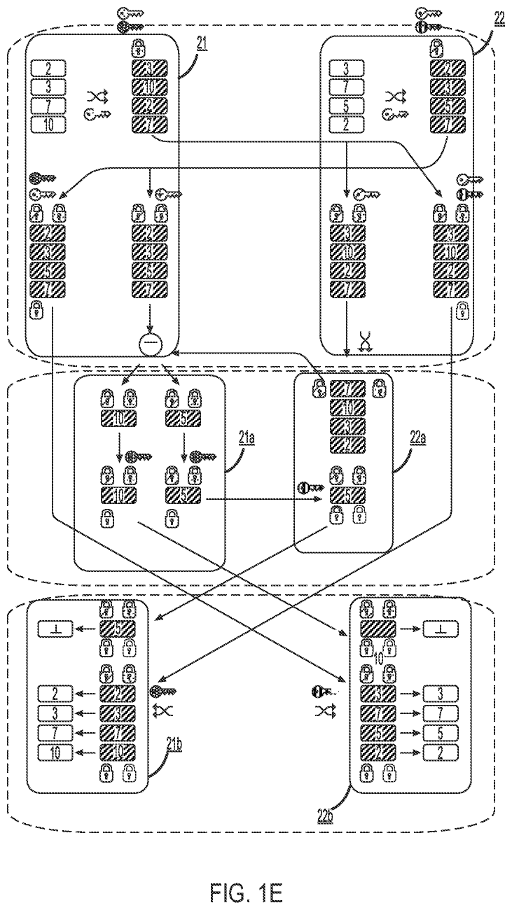

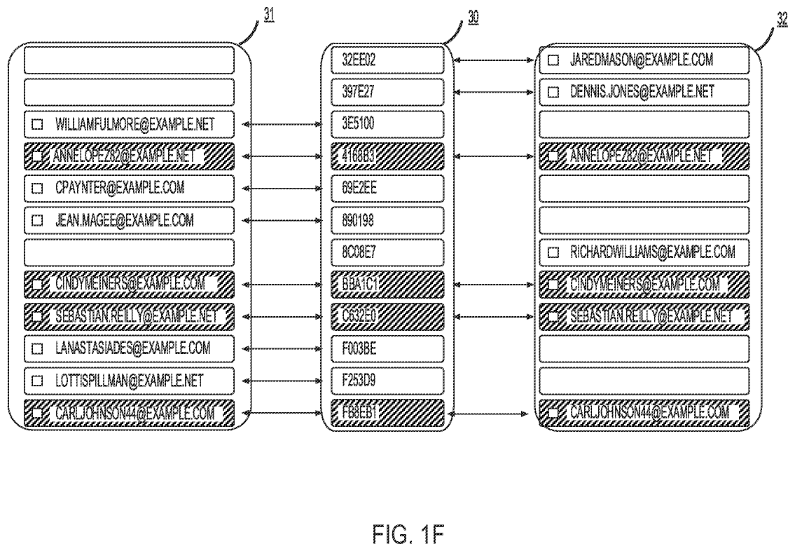

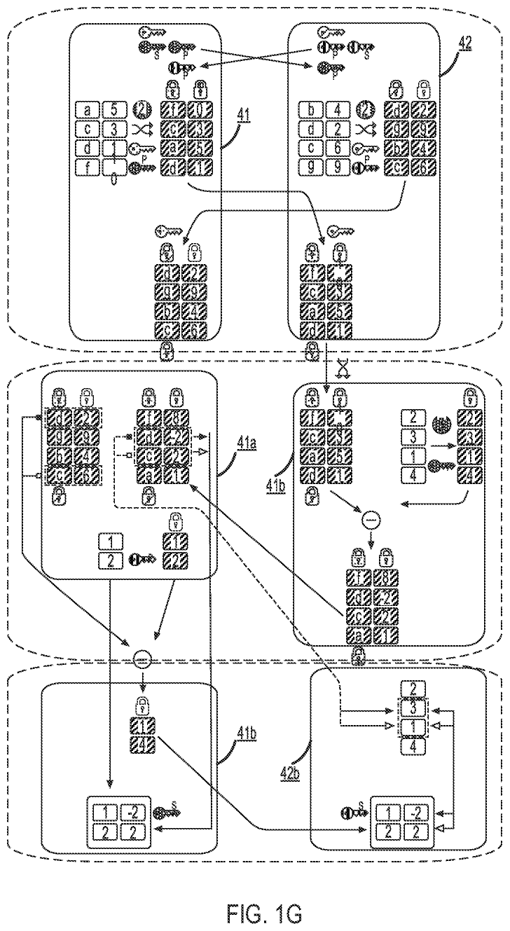

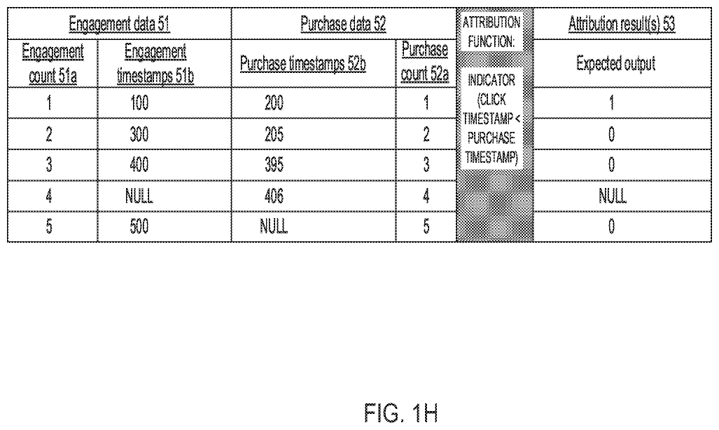

Reference is now made to FIGS. 1A-B. FIG. 1A illustrates a block diagram of a system environment, including a system, that may be implemented to privately join, analyze and share of information based on data available on a plurality of information stores, according to an example. FIG. 1B illustrates a block diagram of the system that may be implemented to privately join, analyze and share of information based on data available on a plurality of information stores, according to an example.

As will be described in the examples below, one or more of system 100, external system 200, external system 210 user device 300 and system environment 1000 shown in FIGS. 1A-B may be utilized, accessed or operated by a service provider to privately join, analyze and share of information based on data available on a plurality of information stores. It should be appreciated that one or more of the system 100, the external system 200, the external system 210, the user device 300 and the system environment 1000 depicted in FIGS. 1A-B may be provided as examples. Thus, one or more of the system 100, the external system 200 the user device 300 and the system environment 1000 may or may not include additional features and some of the features described herein may be removed and/or modified without departing from the scopes of the system 100, the external system 200 and the external system 210, the user device 300 and the system environment 1000 outlined herein. Moreover, in some examples, the system 100, the external system 200, the external system 210, and/or the user device 300 may be or associated with a social networking system, a content sharing network, an advertisement system, an online system, and/or any other system that facilitates any variety of digital content in personal, social, commercial, financial, and/or enterprise environments.

While the servers, systems, subsystems, and/or other computing devices shown in FIGS. 1A-B may be shown as single components or elements, it should be appreciated that one of ordinary skill in the art would recognize that these single components or elements may represent multiple components or elements, and that these components or elements may be connected via one or more networks. Also, middleware (not shown) may be included with any of the elements or components described herein. The middleware may include software hosted by one or more servers. Furthermore, it should be appreciated that some of the middleware or servers may or may not be needed to achieve functionality. Other types of servers, middleware, systems, platforms, and applications not shown may also be provided at the front-end or back-end to facilitate the features and functionalities of the system 100, the external system 200, the external system 210, the user device 300 or the system environment 1000.

It should also be appreciated that the systems and methods described herein may be particularly suited for digital content, but are also applicable to a host of other distributed content or media. These may include, for example, content or media associated with data management platforms, search or recommendation engines, social media, and/or data communications involving communication of potentially personal, private, or sensitive data or information. These and other benefits will be apparent in the descriptions provided herein.

In some examples, the external system 200 and the external system 210 may include any number of servers, hosts, systems, and/or databases that store data to be accessed by the system 100, the user device 300, and/or other network elements (not shown) in the system environment 1000. In addition, in some examples, the servers, hosts, systems, and/or databases of the external system 200 may include one or more storage mediums storing any data. So, in some examples, the external system 200 may be operated by a first service provider to store information related to advertisement and/or content items viewed by users, while the external system 210 may be operated by a second service provider to store time of purchase information. Also, in these examples, the instructions on the system 100 may access the information stored on the external system 200 and the external system 210 to privately join, analyze and share associated information as described herein.

In some examples, and as will be described in further detail below, the user device 300 may be utilized to, among other things, browse content such as content provided by a content platform (e.g., a social media platform). In some examples, the user device 300 may be electronic or computing devices configured to transmit and/or receive data. In this regard, each of the user device 300 may be any device having computer functionality, such as a radio, a smartphone, a tablet, a laptop, a watch, a desktop, a server, or other computing or entertainment device or appliance.

In some examples, the user device 300 may be mobile devices that may be communicatively coupled to the network 400 and enabled to interact with various network elements over the network 400. In some examples, the user device 300 may execute an application allowing a user of the user device 300 to interact with various network elements on the network 400. Additionally, the user device 300 may execute a browser or application to enable interaction between the user device 300 and the system 100 via the network 400. In some examples and as will also be discussed further below, the user device 300 may be utilized to privately join, analyze and share of information based on data available on a plurality of information stores associated with the user device 300. For example, in some instances, the user device 300 may be used by a customer of an electronic commerce provider to purchase a good or service.

The system environment 1000 may also include the network 400. In operation, one or more of the system 100, the external system 200 and the user device 300 may communicate with one or more of the other devices via the network 400. The network 400 may be a local area network (LAN), a wide area network (WAN), the Internet, a cellular network, a cable network, a satellite network, or other network that facilitates communication between, the system 100, the external system 200, the external system 210, the user device 300 and/or any other system, component, or device connected to the network 400. The network 400 may further include one, or any number, of the exemplary types of networks mentioned above operating as a stand-alone network or in cooperation with each other. For example, the network 400 may utilize one or more protocols of one or more clients or servers to which they are communicatively coupled. The network 400 may facilitate transmission of data according to a transmission protocol of any of the devices and/or systems in the network 400. Although the network 400 is depicted as a single network in the system environment 1000 of FIG. 1A, it should be appreciated that, in some examples, the network 400 may include a plurality of interconnected networks as well.

It should be appreciated that in some examples, and as will be discussed further below, the system 100 may be configured to utilize various techniques and mechanisms to privately join, analyze and share of information based on data available on a plurality of information stores. Details of the system 100 and its operation within the system environment 1000 will be described in more detail below.

As shown in FIGS. 1A-B, the system 100 may include processor 101 and a memory 102. In some examples, the processor 101 may be configured to execute the machine-readable instructions stored in the memory 102. It should be appreciated that the processor 101 may be a semiconductor-based microprocessor, a central processing unit (CPU), an application specific integrated circuit (ASIC), a field-programmable gate array (FPGA), and/or other suitable hardware device.

In some examples, the memory 102 may have stored thereon machine-readable instructions (which may also be termed computer-readable instructions) that the processor 101 may execute. The memory 102 may be an electronic, magnetic, optical, or other physical storage device that contains or stores executable instructions. The memory 102 may be, for example, Random Access memory (RAM), an Electrically Erasable Programmable Read-Only Memory (EEPROM), a storage device, an optical disc, or the like. The memory 102, which may also be referred to as a computer-readable storage medium, may be a non-transitory machine-readable storage medium, where the term “non-transitory” does not encompass transitory propagating signals. It should be appreciated that the memory 102 depicted in FIGS. 1A-B may be provided as an example. Thus, the memory 102 may or may not include additional features, and some of the features described herein may be removed and/or modified without departing from the scope of the memory 102 outlined herein.

It should be appreciated that, and as described further below, the processing performed via the instructions on the memory 102 may or may not be performed, in part or in total, with the aid of other information and data, such as information and data provided by the external system 200, the external system 210 and/or the user device 300. Moreover, and as described further below, it should be appreciated that the processing performed via the instructions on the memory 102 may or may not be performed, in part or in total, with the aid of or in addition to processing provided by other devices, including for example, the external system 200, the external system 210 and/or the user device 300.

In some examples, the instructions 103-107 may provide private joining, analyzing and sharing of information based on data available on a plurality of information stores. In some examples, the instructions 103-107 may enable leverage application cryptography to perform joint data computations (e.g., joint record-level computations) across entities, while verifiably protecting personal data and preventing undesirable leakage to unintended parties.

Furthermore, in some examples, the instructions 103-107 may privately align (i.e., arrange) data records from disparate data stores, may determine information associated with one or more intersection(s) between the disparate data stores, and may implement one or more predefined condition(s) to perform a computation associated with information in the disparate data stores. More specifically, in some examples, the instructions 103-107 may implement a parallel computation (e.g., a parallel multi-party computation (MPC)) wherein inputs may remain private but an output generated via a data computation (e.g., a record-level computation) may be privately shared amongst associated parties. Furthermore, in some example, the instructions 103-107 may further privately release a result of the data computation to one or more parties while maintaining privacy. That is, in some examples, the instructions 103-107 may implement an output protection that may conceal an output using encryption methods or may release a differentially-private output.

FIG. 1C illustrates a flow diagram of private joining, analyzing and sharing of information as provided by the instructions 103-107. So, in some examples and as discussed further below, the private joining, analyzing and sharing of information may include private aligning of records, performing a private record-level joint computation and a private record-level output release.

In some examples, the memory 102 may store instructions, which when executed by the processor 101, may cause the processor to: access 103 information available in one or more data stores; align 104 information associated with one or more data store(s) to generate an alignment result; perform 105 an aggregation computation to generate an aggregated result; utilize 106 an aligned result to determine a computation result; and generate 107 a private output directed to one or more parties.

It should be appreciated that while examples described below may primarily be directed to electronic commerce, the instructions 103-107 may be directed any other context (e.g., healthcare) where similar data store computations may be applicable as well. Additionally, although not depicted, it should be appreciated that to privately join, analyze and share of information utilizing data available on a plurality of information stores, the instructions 103-107 may be configured to utilize various artificial intelligence (AI) based machine learning (ML) tools. It should also be appreciated that the system 100 may provide other types of machine learning (ML) approaches, such as reinforcement learning, feature learning, anomaly detection, etc.

In some examples, the instructions 103 may be configured to access information available in one or more data stores. As used herein, an “data store” may include any collection of information. In various examples described herein, the data store(s) may take the form of information in databases, database tables or data records. So, in some examples, a first entity (e.g., a social media application provider) may hold first information in a first data store (e.g., a database). In these examples, the first information may include information pertaining to user engagement with content items (e.g., timestamps of user clicks). Also, in some examples, a second entity (e.g., an online e-commerce retailer) may hold second information in a second data store (e.g., a database). In these examples, the second information may include information pertaining to user purchases (e.g., timestamps of user purchase events).

In some examples, the instructions 104 may align (or “match”) information associated with one or more data store(s) to generate an alignment result. As used herein, an “alignment result” may include any computational result of a data alignment process performed between one or more data store(s). So, in some examples, the alignment result may be generated based on an “intersection” (i.e., based on one or commonalities) between the one or more data store(s).

In some examples, the instructions may 104 may align first information on a first data store and second information on a second data store to generate an alignment result. In a first example, an alignment result may indicate whether or not any matches exist between the first data store and the second data store. In a second example, an alignment result may indicate how many matches may exist between the first data store and the second data store.

In some examples, in addition to performing an alignment and determining an alignment result, the instructions 104 may perform an alignment computation associated with the alignment and the alignment result. In a first example, an associated computation may determine whether a match that may exist between the first data store and the second data store may relate to a particular entity (i.e., an individual user). In a second example, the instructions 104 may determine a location of a first data store and/or a second data store where a match may exist. An example of first information and second information to be aligned is shown in FIG. 1D. So, in the example shown, the matches between a first data set (i.e., of emails) associated with Alice and a second data set (i.e., of emails) associated with Bob may include: “annelopez82@example.net”,“sebastian.reilly@example.net”, “carljohnson44@example.com”, and “cindymeiners@example.net”.

In some examples, to generate an alignment result, the instructions 104 may align “rows” of related information between a first data store and a second store. For example, in some instances, this may take the form a single column (e.g., for an email address) of aligned rows, while in other examples, this may take the form of multiple columns of aligned rows (e.g., an email address, phone number and full name).

It should further be appreciated that, in some examples, in generating one or more aligned rows, the one or more aligned rows may not be revealed to the associated entities. So, in some examples, any associated entity may not learn anything about another entity's information except for a final outcome from an associated computation (e.g., an alignment result). Also, in some examples, the instructions 104 may provide (only) a total number of matched records as an alignment result, without revealing any further information to associated entities. As such, in some examples, the instructions 104 may ensure that neither entity may learn which of one or more of its records may be present in the intersection. In some examples, the instructions 104 may output the alignment result as one or more aligned rows, and may implement a double encryption mechanism to encrypt the one or more aligned rows.

In some examples, the instructions 104 may generate a set of keys in order to index one or more aligned rows, and may align the one or more rows between a first data store and a second data store accordingly. As used herein, a key may include any aspect by which data from a data store may be organized. In some instances, the term “key” may be used interchangeably with the term “identifier”. Also, as used herein a “set” of keys may include one or more keys. So, in one example, a first key may be an email address, while a second key may be a phone number. In some examples, the set of keys may organize commonalities across the first data store and the second data store. It should be appreciated that as the number of keys in a set of keys may increase, a number of commonalities determined across the first data store and the second data store may increase as well.

In addition, in some examples, to align information associated with one or more data store(s) and/or to generate an alignment result, the instructions 104 may implement a private matching method that may align one or more rows between a first data store and a second data store. In some examples and as discussed below, the instructions 104 may implement the private matching method to perform various record-level computations while protecting inter-party privacy. An example flow diagram implementation of a private matching method is illustrated in FIG. 1E. So, in some examples and as discussed further herein, the private matching method may include exchanging records, calculating a set difference and outputting a mapping.

In addition, in some examples, to implement a private matching method, the instructions 104 may implement one or more join logic(s) to generate an alignment of rows. In some examples, the instructions 104 may utilize one or more join logic(s) to determine whether a first data (e.g., a data row) in a first data store may match a second data in a second data store.

It should be appreciated that a join logic that may be implemented by the instructions 104 may be based on various aspects, including one or more keys that may be implemented or an importance level associated with each implemented key. In a first example of a join logic that may be implemented, leveraging a Diffie-Hellman style protocol entailing a series of encrypted information exchanges to perform a “full outer join” function and to generate a set of primary keys. In some examples, a Diffie-Hellman style protocol may be included as “base” protocols utilized to privately join datasets. Examples of various protocols are discussed further below. Also, in some examples, the instructions 104 may implement a private matching method utilizing a single key (i.e., a “single-key” implementation). In other examples, the instructions 104 may implement a private matching method using multiple keys (i.e., a “multi-key” implementation)

In a second example of a join logic that may be implemented leveraging a Diffie-Hellman style protocol, the instructions 104 may implement a deterministic unary primary key based join. In some examples, information rows in a data store may be de-duped by collapsing event metadata associated with both parties to obtain one set of unique primary keys (a.k.a. identifiers) per entity.

In some examples, the instructions 104 may enable a first entity to encrypt a first set of identifiers by mapping one or more plain text identifier strings to a point on an elliptic curve (EC) with a private key, shuffle the first set of identifiers, and transmit to a second entity's device. Similarly, the instructions 104 may enable a second entity to encrypt a second set of identifiers by mapping one or more plain text identifier strings to a point on an elliptic curve with a private key, shuffle the second set of identifiers, and transmit to the first entity's server.

In some examples, the encrypted, shuffled identifiers received from the other entity may be encrypted a second time (i.e., resulting in further exponentiation of each point on an elliptical curve) and exchanged. In some examples, a join (i.e., match) may occur on a double-encrypted value.

Furthermore, an encryption may be performed to enable a mapping to original rows while protecting an intersection. In some examples, a first set of random strings may be attached to each input row on both parties, along with a second set of random strings that may correspond to rows that may be present in an “other” party's set but not present in the intersection. Also, in these examples, input files may be sorted by random strings locally, which may also entail that rows may be aligned across the first entity and the second entity.

In a third and fourth example of a join logic(s) that may be implemented, the instructions 104 may implement a composite primary (i.e., single) key based join or a deterministic ranked multi-key based join. In these examples, data rows may be indexed by multiple identifiers, wherein a similar protocol may be implemented via use of multiple encryption types. Also, in these examples, numerous connections may arise which may be resolved using a predefined waterfall structure (e.g., a protocol that may prioritize a match).

It should be appreciated that to privately align information and perform associated computations, the instructions 104 may be configured to implement various protocols. In some examples, the implementation of a protocol may be based on a desired output associated with an alignment result. In some examples, the instructions 104 may implement an “honest-but-curious” approach where a first entity and a second entity may be trusted to follow a given protocol and not deviate. However, in other examples, the instructions 104 may implement an approach directed to countering malicious attacks (i.e., where one entity is maliciously implementing a protocol to learn information of the other entity), wherein an underlying protocol may be updated to counter malicious elements and implement secure computation(s).

It should be appreciated that, in some examples, the instructions 104 may perform computations solely on identifiers. That is, in these examples, the instructions 104 may perform computations on the identifiers but not (any associated) metadata. So, in some examples, the instructions 104 may generate an aligned result by privately aligning records utilizing associated identifiers, without performing computations on associated metadata.

Also, in some examples, the instructions 104 may also provide one or more link(s) back to (original) information in a plurality of data stores. Also, in some examples, the instructions 104 may not provide actual individual data elements in or from the plurality of data stores.

In some examples, the instructions 104 may implement “batching”, where a first entity and a second entity may each provide a fixed set of records (i.e., the “input datasets”) and the instructions 104 may be configured to perform a join operation to release a desired (aggregated) output based on one or more joined datasets. That is, in some examples, the input datasets may be fixed a priori to matching, whereas (receiving of) new data may require re-matching of both the input datasets. In other examples, the instructions 104 may not implement “batching”.

Also, in some examples, the instructions 104 may implement streaming, where a first entity may provide a set of records as input, while a second entity may continuously stream records one at a time or may provide one or more relatively smaller batches of records at a time for joining with records associated with the first entity. In addition, in some examples, the second entity may provide a set of records as input, while the first entity may continuously stream records one at a time or may provide one or more relatively smaller batches of records at a time for joining with records associated with records associated with the second entity. In some examples, streaming may entail input datasets on both first and second entities dynamically changing in real time. In other examples, streaming may not be implemented. It should further be appreciated that the instructions 104 may be configured to implement various join logics as well.

In some examples, the instructions 104 may enable encryption and exchange of information (i.e., data) between entities. So, in one example involving a first entity and a second entity, the instructions 104 may generate two sets of secret keys each. In this example, the first entity and the second entity may use the two sets of secret keys to encrypt data as points on an elliptic curve. In particular, the instructions 104 may shuffle and encrypt data using one of the secret keys, and then send the resulting encrypted data to another entity. So, in some examples, a first secret key that may be used by a first party may only be known to the first party, while a second secret key that may be used by a second party may only be known to the second party. Furthermore, in some examples, the instructions 104 may enable a first entity and a second entity to each generate a copy of an encrypted data received from another entity. In some examples, each entity may encrypt the received encrypted data with one key and may encrypt the received encrypted data with both keys. In some instances, the received encrypted data may be encrypted with two keys, while in other instances the received encrypted data may be encrypted with three keys. In these instances, upon encrypting the received encrypted data, a join function (as discussed above) may be utilized to determine an intersection and/or an alignment result.

In some examples, the instructions 104 may determine a set difference. So, in some examples, received encrypted information may be used to calculate a symmetric set difference. In one example where a first entity may send the received encrypted information with two keys to a second entity after shuffling, the second entity may calculate a symmetric set difference which may allow each entity generate identifiers for records that it may not have. It should be appreciated that if keys were not shuffled prior to sending, the second entity may still deduce matched records. However, by shuffling the keys the instruction 104 may “break” a relationship between the received encrypted information and its unencrypted counterpart.

In some examples, the instructions 104 may generate a mapping (e.g., an output) from an identifier to received encrypted information. Upon generating a mapping between a first entity and a second entity, the instructions 104 may also generate an identifier “spine” by exchanging the received encrypted information that may have been encrypted by using all four keys, undoing their associated shuffling, and appending them to the received encrypted information generated from a (determined) symmetric set difference.

Furthermore, in some examples, upon analyzing one or more aligned rows, the instructions 104 may generate a result store including one or more alignment indicators. In some examples, the result store may include an alignment indicator that typically may be located in a generated column. Moreover, in some examples, a result store generated via the instructions 104 may also include a row for every alignment indicator along with data from a (original) column from a data store. So, in these examples, if one or more columns may have matched, an alignment indicator may be same. However, in other instances where a match may not have occurred, the one or more columns may be null. An example of first information and second information including a column of aligned values is shown in FIG. 1F. So, in the example shown, aligned values between a first data set and a second data set may include: “4168b3”, “bba1c1”, “c632e0”, and “fb8eb1”.

In some examples, the instructions 104 may implement privacy and security features. As used herein, “privacy” of a system may be measured by an amount of information that can be gleaned from a secure system by an unintended entity under an assumed threat model. As used herein, “security” of a system may be a capability of a system to keep an entity's data hidden from other parties. In some examples, privacy and security may rely on a nature of underlying protocols that may be used to enable a join function.

So, in some examples, a first entity's information may not be protected if a second entity may add dummy values to an identifier value (i.e., an identifier vector). In such instances, an attack may be mitigated or minimized by adding noise (i.e., dummy elements) to an intersection. However, it should be appreciated that in some instances, one or both parties may (maliciously) not add the requisite noise element(s).

It should be appreciated that, in some examples, security concerns may arise when a first entity and a second entity may not follow an expected protocol to gain access to an identifier vectors. That is, security concerns may arise by utilizing a (e.g., row-level) secret key instead of a secret key that may be common across rows in order to exponentiate during an encryption phase. So, in these instances, a first (honest) entity using a common secret key across rows (i.e., following protocol) may not be protected as a second entity may learn an intersection by looking up which key may correspond to matched items in the intersection (i.e., by iterating over all possible combinations).

In some examples, the instructions 104 may “leak” particular information while maintaining privacy and security. In a first example, the instructions 104 may leak a size of an intersection. It should be appreciated that such leakage may be acceptable in some instances as it may provide an aligned metric (i.e., an intersection), and may not reveal individual members of the intersection. However, it should also be noted that if a similar protocol may be run multiple times with a single identifier vector differing, it may in some instances reveal the individual members of the intersection. In a second example, the instructions 104 may lead to a location of a matched identifier. In a third example, the instructions 104 may leak a number of identifiers per row.

In some examples, the instructions 105 may perform an aggregation computation to generate an aggregated result. In some examples, the aggregation computation performed by the instructions 105 may be associated with a first data located in a first data store and second data located in a second data store. Furthermore, in some examples, the aggregation computation by the instructions 105 may be associated with on one or more identifiers. In some examples, the first data from the first data store and the second data from the second data store may include metadata. Also, in some examples, the aggregated result may take a form of an aggregated data set (i.e., an aggregation result). That is, in some examples, the instructions 105 may match the first data from the first data store and the second data from the second data store to generate an intersection. Also, in some examples, the aggregated result may be encrypted.

In some examples, an aggregation computation may be performed to not (i.e., obviates any) “link back” to an originating data store. So, in some examples, values included in an aggregated data set may be generated without providing a link (back) to originating values and/or locations. Accordingly, in these examples, the instructions 105 may generate the aggregated data set without utilizing “record-level” information, thereby ensuring that the aggregated data set may not “link back”.

Furthermore, in some examples, the instructions 105 may split values in an aggregated data set based on an association with an entity. So, in one example, the instructions 105 may split a portion of values in an aggregated data set that may be associated with a first party (e.g., a first company) from another portions of values in the aggregated data set that may be associated with a second party (e.g., a second company).

In some examples, primitives such as a secret-sharing-based multi-party computation (MPC), may be implemented. In these examples, the secret-sharing-based protocol(s) may implement secret data (including inputs and intermediate function outcomes) that may be shared by a plurality of parties wherein each party may only hold partial (e.g., encrypted) information and the plurality of parties may be required to come together to recover secret information provided to the parties.

In some examples, the instructions 105 may encrypt metadata after computation(s) on the metadata. As a result, in some examples, the instructions 105 may provide a (resulting) encrypted metadata that may be associated with identifiers and that may be included in an intersection without providing a “linking” back to associated source data.

In some examples, the instructions 105 may implement an inner join to determine the intersection. Also, in some examples, the instructions 105 may implement “rank deterministic matching”, wherein the instructions 105 may be configured to implement multi-key matching join logic per one or more pre-determined input key orderings as specified by a first entity and/or a second entity to enable various forms of join logics (e.g., rank deterministic matching). In some examples, for both multi-key and single-key matching, a link may be established via matching of identifiers. That is, in these examples, fuzzy matches may not be allowed/included. In some examples, in multi-key ranked deterministic matching in particular, numerous connections may be generated that may be resolved using iterative disjunction matching, where records from a first entity may be iteratively matched to at most one record from second entity to resolve “many-many” connections according to one or more predetermined logic(s) specified by either the first entity or the second entity.

In these examples, a record from a first database may be linked to one or more records in a second database if there may be at least one common key. Also in these examples, a predefined identifier ranking may be employed to resolve conflicts by iteratively matching remaining records using one or more keys. Also, in other examples, if a record from a first database may have identifiers that may belong to a first identifier element from multiple records in a second database, the instructions 105 may resolve these randomly.

Furthermore, in some examples, the instructions 105 may only output a link between the records from both databases. An example flow diagram a flow diagram of performing a computation on one or more identifiers is illustrated in FIG. 1G. So, in some examples and as discussed further herein, the identifier-based computation method may include exchanging records and public keys, calculating a set intersection and outputting one or more shares (i.e., shared results).

In some examples, to implement an aggregation computation, the instructions 105 may generate, for a first party and a second party, a pair of public and private keys. Furthermore, the instructions 105 may enable each of the first party and the second party to encrypt, shuffle and send its data records (e.g., timestamps associated with purchase events) to the other party. In some examples, the instructions 105 may exchange public keys for encryption (e.g., Paillier encryption). Upon receiving the data records, the instructions 105 may encrypt the exchanged public keys with a (unique) secret key. As such, the instructions 105 may utilize the doubly encrypted identifiers to be used to match the data records. In some examples, the public keys may be shuffled prior to exchange.

In some examples, to implement an aggregation computation, the instructions 105 may also calculate a set intersection. In these examples, a second party may shuffle data records received and may encrypt an identifier with a (unique) secret key. In some examples, the public keys may be shuffled prior to exchange. Also, in these examples, the instructions 105 may enable choosing of a random number, which may be homomorphically subtracted from the data values using a second party's public key. In some examples, the random numbers (i.e., an offset) may be utilized as additive shares for the second party's values. In some examples, the instructions 105 may send the (now) doubly encrypted identifiers and corresponding data values to a first party, which may be used to match the data records. In some examples, for data records that may be matched, the instructions 105 may further enable a homomorphic subtraction of a random number (i.e., an offset) using the first party's public key.

In some examples, to implement an aggregation computation, the instructions 105 may enable a first party to decrypt values it may have received from a second party to determine a “share” of a value associated with the first party. That is, in some examples, the instructions 105 may enable the first party to send encrypted values to the second party along matching indices, wherein the second party may decrypt the encrypted values to determine a share of a value associated with the second party.

In some examples, the instructions 106 may utilize an alignment result to determine a computation result. That is, in some examples, the instructions 106 may securely perform a secure row-level computation with respect to aligned records across a first information store and a second information store. In some examples, inputs may be tagged from one or more of a first entity and a second entity to enable a row-level computation.

In these examples, to generate a computation result, any multi-party secure computation primitive may be utilized to enable performance of a secure row-level computation. In other examples, primitives such as a secret-sharing-based on multi-party computation (MPC) may be implemented. In some examples, garbled circuits (GC) may be an underlying primitive for private attribution. In some examples, garbled circuits (GC) may enable two-party boolean functions, which may be used to perform timestamp comparisons. It should be appreciated that the instructions 106 implementation of garbled circuits (GC) may be done so in either an honest-but-curious model or malicious threat models.

In some examples, to generate a computation result, the instructions 106 may utilize a computation function. So, in some examples, the computation function may be utilized an association between the first data item and the second data item. As used herein, an “association” may be any aspect that may relate to a first data item and a second data item. In some examples, the computation function may be implemented on one or more of the first encrypted data item, the second encrypted data item, a metadata associated with one of the first encrypted data item and the second encrypted data item, and an identifier associated with one of the first encrypted data item and the second encrypted data item.

Indeed, in some examples, the instructions 106 may be configured to implement a computation function of any type, such as comparison functions or summation functions. So, in some examples, the computation function may generate an A/B or result, wherein if a determination may be made in the affirmative an “A” (or “1”) may be output, or if the determination may be made in the negative, a “B” (or “0”) may be output. In some examples, the instructions 106 may utilize aligned data from a social media company providing click-able advertisements and an internet commerce company providing purchase timestamps to determine whether a purchase happened after a user's click on a related advertisement. It should be appreciated that, in the implementation of the computation, no private information from any entity may be revealed during the computation(s).

In some examples relating to electronic commerce transactions, a first entity may gather information as to when (i.e., what time) a purchase of an item occurred, while a second entity may gather information as to when (i.e., at what time) a user may have engaged an associated content item (e.g., an advertisement). In these examples, the instructions 106 may implement a row-level computation with an attribution logic pertaining to any purchase that may have occurred after engagement with an associated content item and within a twenty-four (24) hour period. Also, in these examples, a row-level computation “flow” may include consideration of a single aligned row indicating that a first entity may provide three content item engagements with respective timestamps. Moreover, a second entity may provide corresponding purchase event times into the protocol. In these instances, the instructions 106 may securely and collaboratively compute an attribution function associated with each pair of content item engagement(s) and purchase timestamp(s) vectors. Furthermore, the instructions 106 may also generate a function that may produce an output representing a vector of an attributed conversion count. An example of a joint computation that may be implemented by the instructions 106 is shown in FIG. 1H.

Furthermore, it should also be appreciated that other multi-party secure computations primitives may be utilized as well. In some examples, the instructions 106 may utilize “secret sharing” technologies. That is, in some examples, the instructions 106 may implement variants of secret sharing.

In some examples, the instructions 106 may implement one or more of a computation, a function and/or an associated protocol according to a designated threat model. Accordingly, a computation function and/or an associated protocol chosen for an “honest-but-curious” approach may differ from a computation, a function and/or an associated protocol chosen to counter malicious attacks.

In some examples, the instructions 107 may generate a private output directed to one or more parties. As used herein, a “private” output may include an output that may be intended to only be accessed by a single party. Examples of a private output may include encrypted output or a differentially private output. As used herein, a “differentially private” output may include a private output that may be accessible by a party only based an association with the private output. An example of a differentially private output that may be an output to which “noise” may be added that may only be removed (i.e., accessed) by a particular party.

In some examples, a record-level output may be generated for each row that may be indexed by both parties utilizing a secure computation. However, in some examples, an output may not be revealed in order to protect record-level privacy.

In some examples, the instructions 107 may utilize one or more of a plurality of output formats (e.g. encrypted, differentially private). So, in a first example, the instructions 107 may implement a “locally differential private release” format, wherein each row may produce an output that may be protected using one or more local differential privacy mechanisms. Also, in some examples, the instructions 107 may further be configured to reveal computed outputs to one or more parties at “record-level”. In other examples, the instructions 107 may be configured to reveal computed outputs in an “aggregated” format.

Also, in some examples, a binary output may be protected using a randomized response mechanism. In some examples, entail securely generating binary, uniform random variables. In some examples, the generation of these variables may leverage “XOR” summing of independent, random Bernoulli variables that may be generated independently by individual parties. In such instances, an attack may be mitigated or minimized by adding noise (i.e., dummy elements) to an intersection.

In some examples, the instructions 107 may provide an encrypted output, wherein each row-level computation may be provided via an encrypted output format. So, in one example, a first entity and a second entity may receive secret shared values, wherein the shared values in and of themselves may not reveal anything about a determined outcome. In such examples, a subsequent application may have to integrate or “plug-in” to reveal (i.e., access) a secret shared output in order to collaboratively compute an aggregated downstream output. It should be appreciated that a transformation of a row-level joint computation via the instructions 107 may also require a secure computation to not reveal any intermediary (e.g., backend) information or output to a first entity or a second entity. In some examples, random values from predetermined probability distributions (e.g. Laplace, Gaussian, etc.) may be generated securely and collaboratively by both parties using multi-party computation (MPC) protocols, and may be added to an encrypted output prior to revealing the encrypted output to one or both parties to ensure a differentially private output and to prevent a variety of privacy attacks. In some examples, and in particular in the case of binary outcome values, randomized response mechanisms may be implemented inside multi-party computation (MPC) protocols to offer formal differential privacy guarantees and plausible deniability to participating parties.

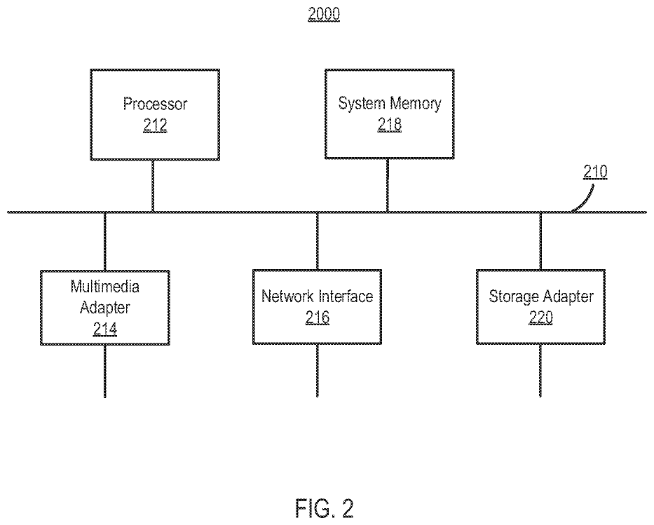

FIG. 2 illustrates a block diagram of a computer system for privately joining, analyzing and sharing of information based on data available on a plurality of information stores, according to an example. In some examples, the system 2000 may be associated with the system 100 to perform the functions and features described herein. The system 2000 may include, among other things, an interconnect 210, a processor 212, a multimedia adapter 214, a network interface 216, a system memory 218, and a storage adapter 220.

The interconnect 210 may interconnect various subsystems, elements, and/or components of the external system 200. As shown, the interconnect 210 may be an abstraction that may represent any one or more separate physical buses, point-to-point connections, or both, connected by appropriate bridges, adapters, or controllers. In some examples, the interconnect 210 may include a system bus, a peripheral component interconnect (PCI) bus or PCI-Express bus, a HyperTransport or industry standard architecture (ISA)) bus, a small computer system interface (SCSI) bus, a universal serial bus (USB), IIC (I2C) bus, or an Institute of Electrical and Electronics Engineers (IEEE) standard 1394 bus, or “firewire,” or other similar interconnection element.

In some examples, the interconnect 210 may allow data communication between the processor 212 and system memory 218, which may include read-only memory (ROM) or flash memory (neither shown), and random access memory (RAM) (not shown). It should be appreciated that the RAM may be the main memory into which an operating system and various application programs may be loaded. The ROM or flash memory may contain, among other code, the Basic Input-Output system (BIOS) which controls basic hardware operation such as the interaction with one or more peripheral components.

The processor 212 may be the central processing unit (CPU) of the computing device and may control overall operation of the computing device. In some examples, the processor 212 may accomplish this by executing software or firmware stored in system memory 218 or other data via the storage adapter 220. The processor 212 may be, or may include, one or more programmable general-purpose or special-purpose microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices.

The multimedia adapter 214 may connect to various multimedia elements or peripherals. These may include devices associated with visual (e.g., video card or display), audio (e.g., sound card or speakers), and/or various input/output interfaces (e.g., mouse, keyboard, touchscreen).

The network interface 216 may provide the computing device with an ability to communicate with a variety of remote devices over a network (e.g., network 200 of FIG. 1A) and may include, for example, an Ethernet adapter, a Fibre Channel adapter, and/or other wired- or wireless-enabled adapter. The network interface 216 may provide a direct or indirect connection from one network element to another, and facilitate communication and between various network elements.

The storage adapter 220 may connect to a standard computer-readable medium for storage and/or retrieval of information, such as a fixed disk drive (internal or external).

Many other devices, components, elements, or subsystems (not shown) may be connected in a similar manner to the interconnect 210 or via a network (e.g., network 200 of FIG. 1A). Conversely, all of the devices shown in FIG. 2 need not be present to practice the present disclosure. The devices and subsystems can be interconnected in different ways from that shown in FIG. 2. Code to implement the dynamic approaches for payment gateway selection and payment transaction processing of the present disclosure may be stored in computer-readable storage media such as one or more of system memory 218 or other storage. Code to implement the dynamic approaches for payment gateway selection and payment transaction processing of the present disclosure may also be received via one or more interfaces and stored in memory. The operating system provided on system 100 may be MS-DOS, MS-WINDOWS, OS/2, OS X, IOS, ANDROID, UNIX, Linux, or another operating system.

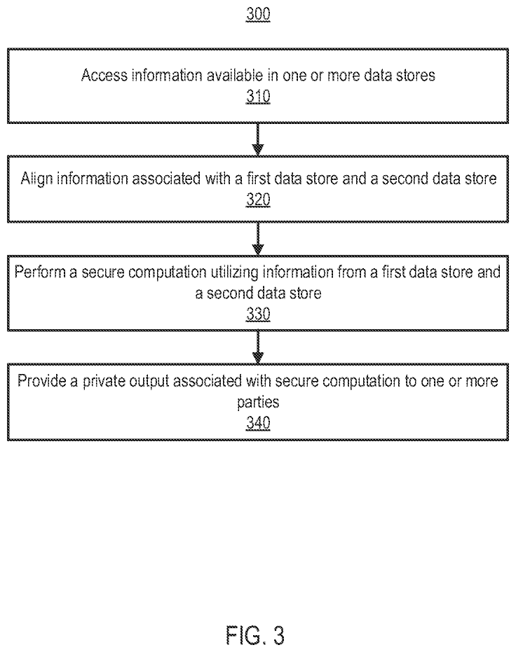

FIG. 3 illustrates a method 300 for privately joining, analyzing and sharing of information based on data available on a plurality of information stores, according to an example. The method 300 is provided by way of example, as there may be a variety of ways to carry out the method described herein. Each block shown in FIG. 3 may further represent one or more processes, methods, or subroutines, and one or more of the blocks may include machine-readable instructions stored on a non-transitory computer-readable medium and executed by a processor or other type of processing circuit to perform one or more operations described herein.

Although the method 300 is primarily described as being performed by system 100 as shown in FIGS. 3A-B, the method 300 may be executed or otherwise performed by other systems, or a combination of systems. It should be appreciated that, in some examples, the method 300 may be configured to incorporate artificial intelligence (AI) or deep learning techniques, as described above. It should also be appreciated that, in some examples, the method 300 may be implemented in conjunction with a content platform (e.g., a social media platform) to generate and deliver content to a user via remote rendering and real-time streaming.

Reference is now made with respect to FIG. 3. At 310, the processor 101 may access information available in one or more data stores. So, in some examples, a first entity (e.g., a social media application provider) may hold first user information (e.g., timestamps of user clicks) in a first data store (e.g., a database). Also, in some examples, a second entity (e.g., an online e-commerce retailer) may hold second user information (e.g., purchase events with timestamps) in a second data store (e.g., a database).

At 320, the processor 101 may privately align (or “match”) information associated with a first data store and a second data store. In some examples, the processor 101 may access and analyze first information from a first data store and second information from a second data store. In some examples, the processor 101 may align first information from a first data store and second information from a second data store into one or more rows. In some instances, a final outcome (of aligning) may also be referred to as an “intersection”. In some examples, the processor 101 may implement a matching method. In some examples, the processor 101 may implement a Diffie-Hellman protocol in order to perform a “full outer join” function and generate a set of primary keys.

At 330, the processor 101 may perform a row-level joint computation. in some examples, the processor 101 may securely perform a secure row-level computation with respect to aligned records across first information store and a second information store. In some examples, inputs may be tagged from one or more of a first entity and a second entity to enable a row-level computation. In some examples, garbled circuits (GC) may be underlying “primitive” for attribution implementation, and in other examples, secret-sharing (SS) based protocols may be utilized as an underlying “primitive” as well.

At 340, the processor 101 may generate an output associated with a row-level joint computation. In some examples, the processor 101 may utilize one or more of a plurality of output formats (e.g. encrypted, differentially private). So, in a first example, the processor 101 may implement a “locally differential private release” format, wherein each row may produce an output that may be protected using one or more local differential privacy mechanisms. Also, in some examples, the processor 101 may provide an encrypted output, wherein each row-level computation may be provided via encrypted output format.

Although the methods and systems as described herein may be directed mainly to digital content, such as videos or interactive media, it should be appreciated that the methods and systems as described herein may be used for other types of content or scenarios as well. Other applications or uses of the methods and systems as described herein may also include social networking, marketing, content-based recommendation engines, and/or other types of knowledge or data-driven systems.

It should be noted that the functionality described herein may be subject to one or more privacy policies, described below, enforced by the system 100, the external system 200, and the user devices 300 that may bar use of images for concept detection, recommendation, generation, and analysis.

In particular examples, one or more objects of a computing system may be associated with one or more privacy settings. The one or more objects may be stored on or otherwise associated with any suitable computing system or application, such as, for example, the system 100, the external system 200, and the user devices 300, a social-networking application, a messaging application, a photo-sharing application, or any other suitable computing system or application. Although the examples discussed herein may be in the context of an online social network, these privacy settings may be applied to any other suitable computing system. Privacy settings (or “access settings”) for an object may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular user or other entity to access that object, the object may be described as being “visible” with respect to that user or other entity. As an example and not by way of limitation, a user of the online social network may specify privacy settings for a user-profile page that identify a set of users that may access work-experience information on the user-profile page, thus excluding other users from accessing that information.

In particular examples, privacy settings for an object may specify a “blocked list” of users or other entities that should not be allowed to access certain information associated with the object. In particular examples, the blocked list may include third-party entities. The blocked list may specify one or more users or entities for which an object is not visible. As an example and not by way of limitation, a user may specify a set of users who may not access photo albums associated with the user, thus excluding those users from accessing the photo albums (while also possibly allowing certain users not within the specified set of users to access the photo albums). In particular examples, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example and not by way of limitation, a particular concept node corresponding to a particular photo may have a privacy setting specifying that the photo may be accessed only by users tagged in the photo and friends of the users tagged in the photo. In particular examples, privacy settings may allow users to opt in to or opt out of having their content, information, or actions stored/logged by the system 100, the external system 200, and the user devices 300, or shared with other systems. Although this disclosure describes using particular privacy settings in a particular manner, this disclosure contemplates using any suitable privacy settings in any suitable manner.

In particular examples, the system 100, the external system 200, and the user devices 300 may present a “privacy wizard” (e.g., within a webpage, a module, one or more dialog boxes, or any other suitable interface) to the first user to assist the first user in specifying one or more privacy settings. The privacy wizard may display instructions, suitable privacy-related information, current privacy settings, one or more input fields for accepting one or more inputs from the first user specifying a change or confirmation of privacy settings, or any suitable combination thereof. In particular examples, the system 100, the external system 200, and the user devices 300 may offer a “dashboard” functionality to the first user that may display, to the first user, current privacy settings of the first user. The dashboard functionality may be displayed to the first user at any appropriate time (e.g., following an input from the first user summoning the dashboard functionality, following the occurrence of a particular event or trigger action). The dashboard functionality may allow the first user to modify one or more of the first user's current privacy settings at any time, in any suitable manner (e.g., redirecting the first user to the privacy wizard).

Privacy settings associated with an object may specify any suitable granularity of permitted access or denial of access. As an example and not by way of limitation, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In particular examples, different objects of the same type associated with a user may have different privacy settings. Different types of objects associated with a user may have different types of privacy settings. As an example and not by way of limitation, a first user may specify that the first user's status updates are public, but any images shared by the first user are visible only to the first user's friends on the online social network. As another example and not by way of limitation, a user may specify different privacy settings for different types of entities, such as individual users, friends-of-friends, followers, user groups, or corporate entities. As another example and not by way of limitation, a first user may specify a group of users that may view videos posted by the first user, while keeping the videos from being visible to the first user's employer. In particular examples, different privacy settings may be provided for different user groups or user demographics. As an example and not by way of limitation, a first user may specify that other users who attend the same university as the first user may view the first user's pictures, but that other users who are family members of the first user may not view those same pictures.

In particular examples, the system 100, the external system 200, and the user devices 300 may provide one or more default privacy settings for each object of a particular object-type. A privacy setting for an object that is set to a default may be changed by a user associated with that object. As an example and not by way of limitation, all images posted by a first user may have a default privacy setting of being visible only to friends of the first user and, for a particular image, the first user may change the privacy setting for the image to be visible to friends and friends-of-friends.

In particular examples, privacy settings may allow a first user to specify (e.g., by opting out, by not opting in) whether the system 100, the external system 200, the external system 210, and the user devices 300 may receive, collect, log, or store particular objects or information associated with the user for any purpose. In particular examples, privacy settings may allow the first user to specify whether particular applications or processes may access, store, or use particular objects or information associated with the user. The privacy settings may allow the first user to opt in or opt out of having objects or information accessed, stored, or used by specific applications or processes. The system 100, the external system 200, the external system 210, and the user devices 300 may access such information in order to provide a particular function or service to the first user, without the system 100, the external system 200, the external system 210, and the user devices 300 having access to that information for any other purposes. Before accessing, storing, or using such objects or information, the system 100, the external system 200, the external system 210, and the user devices 300 may prompt the user to provide privacy settings specifying which applications or processes, if any, may access, store, or use the object or information prior to allowing any such action. As an example and not by way of limitation, a first user may transmit a message to a second user via an application related to the online social network (e.g., a messaging app), and may specify privacy settings that such messages should not be stored by the system 100, the external system 200, the external system 210, and the user devices 300.

In particular examples, a user may specify whether particular types of objects or information associated with the first user may be accessed, stored, or used by the system 100, the external system 200, the external system 210, and the user devices 300. As an example and not by way of limitation, the first user may specify that images sent by the first user through the system 100, the external system 200, the external system 210, and the user devices 300 may not be stored by the system 100, the external system 200, the external system 210, and the user devices 300. As another example and not by way of limitation, a first user may specify that messages sent from the first user to a particular second user may not be stored by the system 100, the external system 200, the external system 210, and the user devices 300. As yet another example and not by way of limitation, a first user may specify that all objects sent via a particular application may be saved by the system 100, the external system 200, the external system 210, and the user devices 300.

In particular examples, privacy settings may allow a first user to specify whether particular objects or information associated with the first user may be accessed from the system 100, the external system 200, the external system 210, and the user devices 300. The privacy settings may allow the first user to opt in or opt out of having objects or information accessed from a particular device (e.g., the phone book on a user's smart phone), from a particular application (e.g., a messaging app), or from a particular system (e.g., an email server). The system 100, the external system 200, the external system 210, and the user devices 300 may provide default privacy settings with respect to each device, system, or application, and/or the first user may be prompted to specify a particular privacy setting for each context. As an example and not by way of limitation, the first user may utilize a location-services feature of the system 100, the external system 200, the external system 210, and the user devices 300 to provide recommendations for restaurants or other places in proximity to the user. The first user's default privacy settings may specify that the system 100, the external system 200, the external system 210, and the user devices 300 may use location information provided from one of the user devices 300 of the first user to provide the location-based services, but that the system 100, the external system 200, the external system 210, and the user devices 300 may not store the location information of the first user or provide it to any external system. The first user may then update the privacy settings to allow location information to be used by a third-party image-sharing application in order to geo-tag photos.

In particular examples, privacy settings may allow a user to specify whether current, past, or projected mood, emotion, or sentiment information associated with the user may be determined, and whether particular applications or processes may access, store, or use such information. The privacy settings may allow users to opt in or opt out of having mood, emotion, or sentiment information accessed, stored, or used by specific applications or processes. The system 100, the external system 200, the external system 210, and the user devices 300 may predict or determine a mood, emotion, or sentiment associated with a user based on, for example, inputs provided by the user and interactions with particular objects, such as pages or content viewed by the user, posts or other content uploaded by the user, and interactions with other content of the online social network. In particular examples, the system 100, the external system 200, the external system 210, and the user devices 300 may use a user's previous activities and calculated moods, emotions, or sentiments to determine a present mood, emotion, or sentiment. A user who wishes to enable this functionality may indicate in their privacy settings that they opt in to the system 100, the external system 200, the external system 210, and the user devices 300 receiving the inputs necessary to determine the mood, emotion, or sentiment. As an example and not by way of limitation, the system 100, the external system 200, the external system 210, and the user devices 300 may determine that a default privacy setting is to not receive any information necessary for determining mood, emotion, or sentiment until there is an express indication from a user that the system 100, the external system 200, the external system 210, and the user devices 300 may do so. By contrast, if a user does not opt in to the system 100, the external system 200, the external system 210, and the user devices 300 receiving these inputs (or affirmatively opts out of the system 100, the external system 200, the external system 210, and the user devices 300 receiving these inputs), the system 100, the external system 200, the external system 210, and the user devices 300 may be prevented from receiving, collecting, logging, or storing these inputs or any information associated with these inputs. In particular examples, the system 100, the external system 200, the external system 210, and the user devices 300 may use the predicted mood, emotion, or sentiment to provide recommendations or advertisements to the user. In particular examples, if a user desires to make use of this function for specific purposes or applications, additional privacy settings may be specified by the user to opt in to using the mood, emotion, or sentiment information for the specific purposes or applications. As an example and not by way of limitation, the system 100, the external system 200, the external system 210, and the user devices 300 may use the user's mood, emotion, or sentiment to provide newsfeed items, pages, friends, or advertisements to a user. The user may specify in their privacy settings that the system 100, the external system 200, the external system 210, and the user devices 300 may determine the user's mood, emotion, or sentiment. The user may then be asked to provide additional privacy settings to indicate the purposes for which the user's mood, emotion, or sentiment may be used. The user may indicate that the system 100, the external system 200, the external system 210, and the user devices 300 may use his or her mood, emotion, or sentiment to provide newsfeed content and recommend pages, but not for recommending friends or advertisements. The system 100, the external system 200, the external system 210, and the user devices 300 may then only provide newsfeed content or pages based on user mood, emotion, or sentiment, and may not use that information for any other purpose, even if not expressly prohibited by the privacy settings.

In particular examples, privacy settings may allow a user to engage in the ephemeral sharing of objects on the online social network. Ephemeral sharing refers to the sharing of objects (e.g., posts, photos) or information for a finite period of time. Access or denial of access to the objects or information may be specified by time or date. As an example and not by way of limitation, a user may specify that a particular image uploaded by the user is visible to the user's friends for the next week, after which time the image may no longer be accessible to other users. As another example and not by way of limitation, a company may post content related to a product release ahead of the official launch, and specify that the content may not be visible to other users until after the product launch.

In particular examples, for particular objects or information having privacy settings specifying that they are ephemeral, the system 100, the external system 200, the external system 210, and the user devices 300 may be restricted in its access, storage, or use of the objects or information. The system 100, the external system 200, the external system 210, and the user devices 300 may temporarily access, store, or use these particular objects or information in order to facilitate particular actions of a user associated with the objects or information, and may subsequently delete the objects or information, as specified by the respective privacy settings. As an example and not by way of limitation, a first user may transmit a message to a second user, and the system 100, the external system 200, the external system 210, and the user devices 300 may temporarily store the message in a content data store until the second user has viewed or downloaded the message, at which point the system 100, the external system 200, the external system 210, and the user devices 300 may delete the message from the data store. As another example and not by way of limitation, continuing with the prior example, the message may be stored for a specified period of time (e.g., 2 weeks), after which point the system 100, the external system 200, the external system 210, and the user devices 300 may delete the message from the content data store.

In particular examples, privacy settings may allow a user to specify one or more geographic locations from which objects can be accessed. Access or denial of access to the objects may depend on the geographic location of a user who is attempting to access the objects. As an example and not by way of limitation, a user may share an object and specify that only users in the same city may access or view the object. As another example and not by way of limitation, a first user may share an object and specify that the object is visible to second users only while the first user is in a particular location. If the first user leaves the particular location, the object may no longer be visible to the second users. As another example and not by way of limitation, a first user may specify that an object is visible only to second users within a threshold distance from the first user. If the first user subsequently changes location, the original second users with access to the object may lose access, while a new group of second users may gain access as they come within the threshold distance of the first user.

In particular examples, the system 100, the external system 200, the external system 210, and the user devices 300 may have functionalities that may use, as inputs, personal or biometric information of a user for user-authentication or experience-personalization purposes. A user may opt to make use of these functionalities to enhance their experience on the online social network. As an example and not by way of limitation, a user may provide personal or biometric information to the system 100, the external system 200, the external system 210, and the user devices 300. The user's privacy settings may specify that such information may be used only for particular processes, such as authentication, and further specify that such information may not be shared with any external system or used for other processes or applications associated with the system 100, the external system 200, the external system 210, and the user devices 300. As another example and not by way of limitation, the system 100, the external system 200, the external system 210, and the user devices 300 may provide a functionality for a user to provide voice-print recordings to the online social network. As an example and not by way of limitation, if a user wishes to utilize this function of the online social network, the user may provide a voice recording of his or her own voice to provide a status update on the online social network. The recording of the voice-input may be compared to a voice print of the user to determine what words were spoken by the user. The user's privacy setting may specify that such voice recording may be used only for voice-input purposes (e.g., to authenticate the user, to send voice messages, to improve voice recognition in order to use voice-operated features of the online social network), and further specify that such voice recording may not be shared with any external system or used by other processes or applications associated with the system 100, the external system 200, the external system 210, and the user devices 300. As another example and not by way of limitation, the system 100, the external system 200, the external system 210, and the user devices 300 may provide a functionality for a user to provide a reference image (e.g., a facial profile, a retinal scan) to the online social network. The online social network may compare the reference image against a later-received image input (e.g., to authenticate the user, to tag the user in photos). The user's privacy setting may specify that such voice recording may be used only for a limited purpose (e.g., authentication, tagging the user in photos), and further specify that such voice recording may not be shared with any external system or used by other processes or applications associated with the system 100, the external system 200, the external system 210, and the user devices 300.

In particular examples, changes to privacy settings may take effect retroactively, affecting the visibility of objects and content shared prior to the change. As an example and not by way of limitation, a first user may share a first image and specify that the first image is to be public to all other users. At a later time, the first user may specify that any images shared by the first user should be made visible only to a first user group. The system 100, the external system 200, the external system 210, and the user devices 300 may determine that this privacy setting also applies to the first image and make the first image visible only to the first user group. In particular examples, the change in privacy settings may take effect only going forward. Continuing the example above, if the first user changes privacy settings and then shares a second image, the second image may be visible only to the first user group, but the first image may remain visible to all users. In particular examples, in response to a user action to change a privacy setting, the system 100, the external system 200, the external system 210, and the user devices 300 may further prompt the user to indicate whether the user wants to apply the changes to the privacy setting retroactively. In particular examples, a user change to privacy settings may be a one-off change specific to one object. In particular examples, a user change to privacy may be a global change for all objects associated with the user.

In particular examples, the system 100, the external system 200, the external system 210, and the user devices 300 may determine that a first user may want to change one or more privacy settings in response to a trigger action associated with the first user. The trigger action may be any suitable action on the online social network. As an example and not by way of limitation, a trigger action may be a change in the relationship between a first and second user of the online social network (e.g., “un-friending” a user, changing the relationship status between the users). In particular examples, upon determining that a trigger action has occurred, the system 100, the external system 200, the external system 210, and the user devices 300 may prompt the first user to change the privacy settings regarding the visibility of objects associated with the first user. The prompt may redirect the first user to a workflow process for editing privacy settings with respect to one or more entities associated with the trigger action. The privacy settings associated with the first user may be changed only in response to an explicit input from the first user, and may not be changed without the approval of the first user. As an example and not by way of limitation, the workflow process may include providing the first user with the current privacy settings with respect to the second user or to a group of users (e.g., un-tagging the first user or second user from particular objects, changing the visibility of particular objects with respect to the second user or group of users), and receiving an indication from the first user to change the privacy settings based on any of the methods described herein, or to keep the existing privacy settings.

In particular examples, a user may need to provide verification of a privacy setting before allowing the user to perform particular actions on the online social network, or to provide verification before changing a particular privacy setting. When performing particular actions or changing a particular privacy setting, a prompt may be presented to the user to remind the user of his or her current privacy settings and to ask the user to verify the privacy settings with respect to the particular action. Furthermore, a user may need to provide confirmation, double-confirmation, authentication, or other suitable types of verification before proceeding with the particular action, and the action may not be complete until such verification is provided. As an example and not by way of limitation, a user's default privacy settings may indicate that a person's relationship status is visible to all users (e.g., “public”). However, if the user changes his or her relationship status, the system 100, the external system 200, the external system 210, and the user devices 300 may determine that such action may be sensitive and may prompt the user to confirm that his or her relationship status should remain public before proceeding. As another example and not by way of limitation, a user's privacy settings may specify that the user's posts are visible only to friends of the user. However, if the user changes the privacy setting for his or her posts to being public, the system 100, the external system 200, the external system 210, and the user devices 300 may prompt the user with a reminder of the user's current privacy settings of posts being visible only to friends, and a warning that this change will make all of the user's past posts visible to the public. The user may then be required to provide a second verification, input authentication credentials, or provide other types of verification before proceeding with the change in privacy settings. In particular examples, a user may need to provide verification of a privacy setting on a periodic basis. A prompt or reminder may be periodically sent to the user based either on time elapsed or a number of user actions. As an example and not by way of limitation, the system 100, the external system 200, the external system 210, and the user devices 300 may send a reminder to the user to confirm his or her privacy settings every six months or after every ten photo posts. In particular examples, privacy settings may also allow users to control access to the objects or information on a per-request basis. As an example and not by way of limitation, the system 100, the external system 200, the external system 210, and the user devices 300 may notify the user whenever an external system attempts to access information associated with the user, and require the user to provide verification that access should be allowed before proceeding.

What has been described and illustrated herein are examples of the disclosure along with some variations. The terms, descriptions, and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

1. A system, comprising:
a processor;
a memory storing instructions, which when executed by the processor, cause the processor to:
access a first encrypted data item in a first data store and a second encrypted data item in a second data store, wherein the first encrypted data item is associated with a first entity and the second encrypted data item is associated with a second entity;
align the first encrypted data item and the second encrypted data item to generate an alignment result, wherein the alignment result is generated based on a commonality between the first encrypted data item and the second encrypted data item;
implement a computation function using the alignment result to generate a computation result; and
generate and distribute at least one private output to one of the first entity and the second entity, wherein at least one private output is based on the computation result.

2. The system of claim 1, wherein the computation function is to determine an association between the first encrypted data item and the second encrypted data item.

3. The system of claim 1, wherein the at least one private output includes a first private output for distribution to the first entity and a second private output for distribution to the second entity.

4. The system of claim 1, wherein the alignment result and the computation result is one of encrypted and differentially private.

5. The system of claim 1, wherein the instructions when executed by the processor further cause the processor to implement a join logic to generate the alignment result.

6. The method of claim 1, wherein the alignment result is based on an intersection of the first data store and the second data store.

7. The method of claim 1, wherein the instructions, when executed by the processor, further cause the processor to perform an aggregation computation using the first encrypted data item and the second encrypted data item to generate an aggregation result.

8. A method for private joining, analyzing and sharing of information utilizing data available on a plurality of information stores, comprising:
accessing first encrypted data item in a first data store and a second encrypted data item in a second data store, wherein the first encrypted data item is associated with a first entity and the second encrypted data item is associated with a second entity;
aligning the first encrypted data item and the second encrypted data item to generate an alignment result, wherein the alignment result is generated based on a commonality between the first encrypted data item and the second encrypted data item;
implementing a computation function using the alignment result to generate a computation result; and
distributing at least one private output to one of the first entity and the second entity, wherein the at least one private output is based on the computation result.

9. The method of claim 8, further including determining, using the computation function, an association between the first encrypted data item and the second encrypted data item.

10. The method of claim 8, wherein the at least one private output includes a first private output for distribution to the first entity and a second private output for distribution to the second entity.

11. The method of claim 8, wherein the alignment result is based on an intersection associated with the first data store and the second data store.

12. The method of claim 8, wherein further including generating a set of keys to index the alignment result.

13. The method of claim 9, further including performing an alignment computation to generate the alignment result.

14. The method of claim 13, wherein the alignment result and the computation result is one of encrypted and differentially private.

15. A non-transitory computer-readable storage medium having an executable stored thereon, which when executed instructs a processor to:
access a first encrypted data item in a first data store and a second encrypted data item in a second data store, wherein the first encrypted data item is associated with a first entity and the second encrypted data item is associated with a second entity;
align the first encrypted data item and the second encrypted data item to generate an alignment result, wherein the alignment result is generated based on a commonality between the first encrypted data item and the second encrypted data item;
implement a computation function using the alignment result to generate a computation result; and
distribute the at least one private output to one of the first entity and the second entity, wherein at least one private output is based on the computation result.

16. The non-transitory computer-readable storage medium of claim 15, wherein the computation function is to determine an association between the first to encrypted data item and the second encrypted data item.

17. The non-transitory computer-readable storage medium of claim 15, wherein the at least one private output includes a first private output for distribution to the first entity and a second private output for distribution to the second entity.

18. The non-transitory computer readable storage medium of claim 15, wherein the computation function is implemented with one of secret sharing and garbled circuits (GC) as an underlying primitive.

19. The non-transitory computer-readable storage medium of claim 15, wherein the computation function is implemented on one or more of the first encrypted data item, the second encrypted data item, a metadata associated with one of the first encrypted data item and the second encrypted data item, and an identifier associated with one of the first encrypted data item and the second encrypted data item.

20. The non-transitory computer-readable storage medium of claim 19, wherein the computation function obviates any link back to originating locations of the first encrypted data item and the second encrypted data item.
